(19) United States
(12) Patent Application Publication
(10) Pub. No.: US 2025/0112652 A1
(43) Pub. Date: Apr. 3, 2025

(54) HARDWARE IMPAIRMENT COMPENSATION

(71) Applicant: Telefonaktiebolaget LM Ericsson (publ), Stockholm (SE)

(72) Inventor: Hamed FARHADI, Stockholm (SE)

(21) Appl. No.: 18/834,354

(22) PCT Filed: Feb. 2, 2022
(86) PCT No.: PCT/SE2022/050113

§ 371 Date: Jul. 30, 2024

(51) Int. Cl. H04B 1/04; H04B 17/391

(52) U.S. Cl. CPC H04B 1/0475; H04B 17/3913; H04B 2001/0425

(57) ABSTRACT

A method performed by a receiver for hardware impairment compensation. The method includes receiving a transmitted signal transmitted by a transmitter. The method also includes determining hardware state information (HSI) based on the received signal. The method further includes providing to the transmitter information indicating the HSI, wherein the HSI comprises information that enables the transmitter to compensate for distortion caused by one or more hardware components of the transmitter and/or one or more hardware components of the receiver.

### TECHNICAL FIELD

Disclosed are embodiments related to hardware impairment compensation.

### BACKGROUND

Radio Frequency (RF) hardware impairments of a transmitting network node, such as oscillator phase noise, power amplifier (PA) nonlinearity, and I/Q imbalance, contribute to distortions in the transmitted signal. The overall RF impairments are typically measured using distortion measures such as, for example, the error-vector-magnitude (EVM), Adjacent Channel Leakage Ratio (ACLR), and Intermodulation Distortion (IMD).

To reduce the distortion due to hardware impairments such as, for example, PA nonlinearity, a pre-distortion module (a.k.a., “pre-distorter”) can be implemented before the nonlinearity at the transmitter. For example, the pre-distorter may be located prior to the PA. The pre-distorter is typically implemented in the digital baseband domain and generates a complementary nonlinearity to that of the PA so that the overall system has a linear characteristic. That is, for example, the pre-distorter receives the baseband signal and processing the baseband signal using a pre-distorter function to produce a pre-distorted baseband signal. The pre-distorted baseband signal is then converted to the analog domain using a digital-to-analog converter (DAC) and is up-converted to the RF domain and next fed to the PA. To be able to determine the pre-distorter function, a portion of the signal from the PA is extracted (e.g. using a signal splitter or a coupler) and is down-converted to the baseband signal. The signal is used to estimate the PA model parameters and to compute the parameters (e.g., coefficients) of the pre-distorter function.

The characteristics of the hardware impairments change over time due to different factors such as temperature variations. For example, the performance of the PA depends on different factors including temperature. For instance, for a designed PA, the gain decreases almost linearly and drain current slightly increases in low temperature working conditions. Also, intermodulation distortion (IMD) has temperature dependency and IMD can be improved in low temperature due to the increase of gain and drain current.

The temperature in which a network node is operating can vary due to different reasons, e.g., due on/off of the sleep mode in MIMO systems, changing traffic load, and variations of the power dissipation. The resulting temperature variations cause changes in the quality of the transmit RF hardware which can be measured by different metrics (e.g., by EVM, ACLR, or IMD). The quality of a communication link fluctuates due to these variations, and if not properly compensated for could cause performance degradation

### SUMMARY

Certain challenges presently exist. For instance, existing digital pre-distortion techniques for compensation of the distortions due to hardware impairments rely on a feedback loop at the transmitter for estimating PA model parameters. This increases the cost of the RF chain of the transmitter due to the extra hardware that is needed such as mixer and ADC to realize the feedback loop, and extra energy consumption to perform digital processing that is required for model parameter estimation to be performed at the transmitter. For network nodes that transmit in the uplink (UL) direction (e.g., user equipments (UEs) such as mobile phones, Internet-of-Things (IoT) devices, residential gateways, etc.), the extra hardware leads to extra cost and lower battery life. For network nodes that transmit in the downlink (DL) direction (e.g., base stations), the extra hardware leads to extra cost and increased size and weight of the network node's radio units (due to lower energy efficiency).

Accordingly, in one aspect there is provided a method performed by a receiver for hardware impairment compensation. The method includes receiving a transmitted signal transmitted by a transmitter. The method also includes determining hardware state information, HSI, based on the received signal. The method further includes providing to the transmitter information indicating the HSI, wherein the HSI comprises information that enables the transmitter to compensate for distortion caused by one or more hardware components of the transmitter and/or one or more hardware components of the receiver.

In another aspect there is provided a method performed by the transmitter. The method includes transmitting a signal to a receiver configured to receive the signal. The method also includes receiving from the receiver information indicating hardware state information, HSI, determined by the receiver based on the received signal. The method further includes using the information indicating the HSI to compensate for distortion caused by one or more hardware components of the transmitter and/or one or more hardware components of the receiver.

In another aspect there is provided a computer program comprising instructions which when executed by processing circuitry of a network node, causes the network node to perform one or more of the above described methods. In another aspect there is provided a carrier containing the computer program, wherein the carrier is one of an electronic signal, an optical signal, a radio signal, and a computer readable storage medium.

In another aspect there is provided a network node where the network node is configured to perform one or more of the methods disclosed herein. In some embodiments, the network node includes processing circuitry and a memory containing instructions executable by the processing circuitry, whereby the network node is configured to perform the network node methods disclosed herein.

The embodiments provide many advantageous, such as reducing the complexity of the digital pre-distortion at the transmitter side. Embodiments enable removing the need for sampling, down-conversion, analog-to-digital conversion, and parameter estimation at the transmitter to extract PA parameters to compute the pre-distortion function. This has the advantages of reducing the energy consumption and hence increasing the energy efficiency of the transmitter, and also reducing the cost of the transmitter by removing the need for coupler/splitter, mixer, I/Q demodulator and ADC in the feedback loop of the transmitter. In short, the advantages in the DL scenario (e.g., base station (BS) is transmitting node and a UE is the receiving node) and the UL scenario (UE is transmitting node and BS is receiving node) include: lower complexity at the BS, reduced digital processing at the BS, lower heat dissipation and reduced size of the radio unit of the BS, reduced energy consumption at the UE and increased battery life of the UE, and reduced cost of the UE by removing the RF hardware that are required for the feedback loop in the conventional digital pre-distortion (DPD) design.

Furthermore, the embodiments enable compensation of hardware impairments including PA nonlinearities while the PA is operating at the nonlinear regime, where the PA is more energy efficient, hence improving the energy efficiency of the transmitting network node. This will have the following advantages in the DL and UL scenarios: enables more nonlinear PA operation at BS, increases energy efficiency of BS, reduces the requirements on DPD processing at BS, hence, reduces the energy requirements for digital processing at baseband at BS, lower heat dissipation at BS, smaller BS radio units due to reducing the requirements on heat sinks, enhances DL coverage/throughput, enables more nonlinear PA operation at UE, reduces energy consumption at UE due to performing model parameter estimation to be performed at the base station, longer UE battery lifetime, and enhances UL coverage/throughput.

### BRIEF DESCRIPTION OF THE DRAWINGS

The accompanying drawings, which are incorporated herein and form part of the specification, illustrate various embodiments.

FIG. 1 illustrates a transmitting network node according to an embodiment.

FIG. 2 illustrates a receiving network node according to an embodiment.

FIG. 3 is a message flow diagram illustrating an embodiment.

FIG. 4 is a message flow diagram illustrating an embodiment.

FIG. 5 is a flowchart illustrating a process according to some embodiments.

FIG. 6 is a flowchart illustrating a process according to some embodiments.

FIG. 7 illustrates a base station according to some embodiments.

FIG. 8 illustrates a UE according to some embodiments.

### DETAILED DESCRIPTION

Disclosed herein are methods for the compensation of distortion due to hardware impairments at a first network node (a.k.a., transmitting network node) and/or a second network node (a.k.a., the receiving network node), based on hardware state information (HSI) determined by the receiving network node. The HSI is provided from the receiving network node to the transmitting network node so that the transmitting network node can use the HSI to compensate for distortion caused by one or more hardware components of the transmitting network node and/or one or more hardware components of the receiving network node.

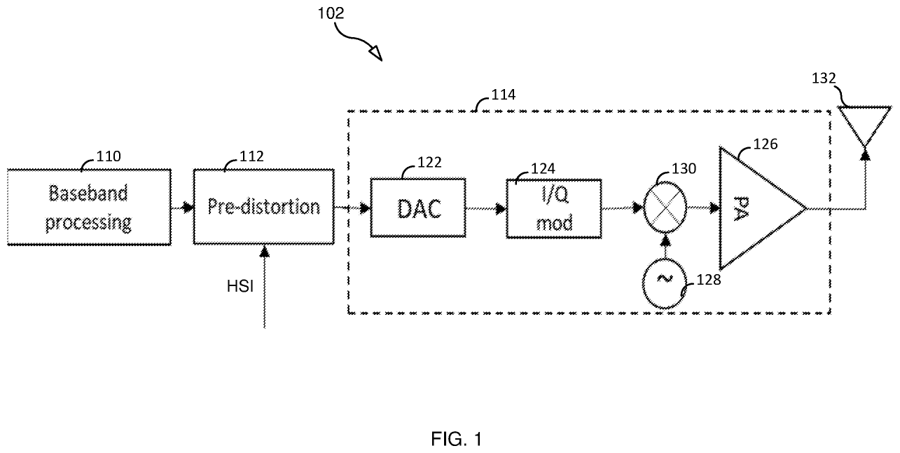

FIG. 1 illustrates a transmitting network node 102 (a.k.a., “transmitter” 102 for short) according to an embodiment. In the embodiment illustrated, transmitter 102 includes: a baseband processing unit 110 that produces a baseband signal; a pre-distortion module 112 (a.k.a., “pre-distorter” 112) that receives the baseband signal and processes the baseband signal using a pre-distortion function to produce a pre-distorted baseband signal; and an RF chain 114 that receives the pre-distorted baseband signal and produces an RF signal that is fed to an antenna system 132 for transmission to a receiving network node. The RF chain 114 in this example includes: a DAC that converts the pre-distorted baseband signal to the analog domain; an I/Q module 124, an oscillator 128, and a mixer 130 for up-converting the analog signal from the DAC to the RF domain; and PA for amplifying the up-converted signal. Advantageously, pre-distorter 112 obtains HSI that was determined by the receiving network node and uses the HSI to determine parameters for the pre-distortion function.

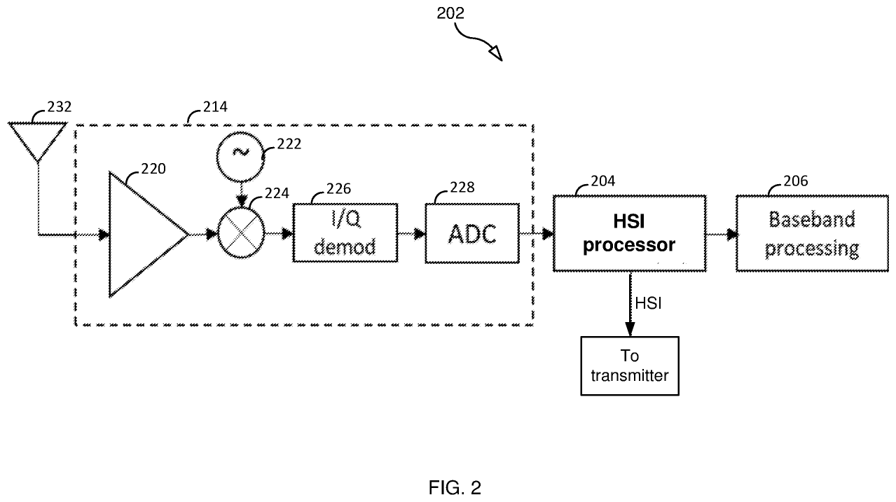

FIG. 2 illustrates a receiving network node 202 (a.k.a., “receiver” 202 for short) according to an embodiment. In the embodiment illustrated, receiver 202 includes: an antenna system 232 for receiving the signal transmitted by transmitter 102; an RF chain 214 for processing the received signal; and HSI processor for generating HSI to provide to transmitter 102 and a baseband processing module 206. The RF chain 214 in this example includes: a low noise amplifier (LNA) 220 followed by a combiner 224 that combines the output of LNA 220 with the output of an oscillator 222 to produce a down converted signal that is demodulated by an I/Q demodulator 226 and the output of I/Q demodulator is fed to an analog-to-digital (ADC) converter that converts the demodulated signal to the digital domain. Following the RF chain 214 is HSI processor 204 that generates HSI based on the output of RF chain 214 (i.e., using the output of RF chain 214 to generate the HSI).

### Hardware State Information (HSI)

HSI comprises information relating to the hardware impairments in the RF chains of the transmitter 102 and receiver 202. The hardware impairments include imperfections in the RF chain 114 of the transmitter 102 and the RF chain 214 of the receiver 202. For example, imperfections due to power amplifier nonlinearities, oscillator phase noise, DAC and ADC quantization noise, and filters nonlinearities. The hardware impairments are subject to variations over time due to different factors for example, temperature variations, changes in the operating point of the hardware due to traffic variations.

In one embodiment, receiver 202 generates the HSI. For example, a parametric model of hardware impairments can be considered, where the model parameters, represented by θ_{HW}, that includes, for example, polynomial coefficients of the nonlinear PA model and oscillator phase noise model parameters. Generalized memory polynomial as presented in the following can be considered as a parametric model for hardware impairments:

$${y}_{GMP} ( n ) = {\sum }_{k = 0}^{{K}_{a} - 1} {\sum }_{l = 0}^{{L}_{a} - 1} {a}_{kl} x ( n - l ) {\vert x ( n - l ) \vert}^{k} + {\sum }_{k = 0}^{{K}_{b}} {\sum }_{l = 0}^{{L}_{b} - 1} {\sum }_{m = 0}^{{M}_{b}} {b}_{klm} x ( n - l ) {\vert x ( n - l - m ) \vert}^{k} + {\sum }_{k = 0}^{{K}_{c}} {\sum }_{l = 0}^{{L}_{c} - 1} {\sum }_{m = 0}^{{M}_{c}} {c}_{klm} x ( n - l ) {\vert x ( n - l + m ) \vert}^{k} ,$$

where y_{GMP} (n) is the output of the model corresponding to the output of the RF hardware chain, and x(n) is the input of the RF hardware chain at time instance n. The parameters αₖₗ, bₖₗₘ, and cₖₗₘ are model parameters that need to be determined for a given radio hardware and hardware operating point.

The model parameters can be identified using any one of the following methods.

In one example, known reference signals (RS) can be transmitted by transmitter 102 to receiver 202 and receiver 202 identifies the model parameters that minimize a distance metric between the received signal and the expected received signal by applying the model to the transmitted reference signal. The distance metric can be for example, mean square error, and the model parameters can be identified using linear minimum mean square error (LMMSE) method to the received signals.

In another example, the hardware impairment model parameters can be identified using the received RS in the I/Q plane as follows. For a given modulation scheme at the transmitter 102, the transmitted symbols prior to transmission through the RF chain are placed at known positions in the I/Q plane. The placement of the symbols in the I/Q plane would be distorted due to RF impairments. For example, the symbols would rotate in random directions due to the oscillator phase noise, where the spreading of the symbols depends on the phase noise power. As another example, the symbols in the constellation diagram would be compressed and rotated due to the power amplifier nonlinearities where the compression is determined by the AM/AM conversion of the PA and the rotation depends on the AM/PM conversion due to the PA nonlinearities. These deformations in the constellation can be used to indirectly estimate the model parameters for hardware impairments.

In another example, receiver 202 identifies the model parameters based on a received signal where the signal is not an RS. For example, the signal can be a data signal comprising payload data. In the example for estimating parameters based on payload data, a set of signals corresponding to payload data will be received which in the I/Q plain will form different clusters, where each cluster is corresponding to each symbol of the constellation. The shape of the clusters will be affected by the hardware impairments and can be used to indirectly estimate the hardware impairment model parameters.

In another example, the hardware impairment model parameters can be identified by applying clustering/classification algorithms on the received signal (e.g., RS or non-RS signal). For example, machine learning techniques can be applied to train models based on a set of measurement signals from hardware subject to different realizations of RF hardware impairments and the corresponding labels which could be the hardware configurations, or parameters or the associated HSI index. Next, the model can be used for the classification based on new measurements of the received signal to find the corresponding HSI index.

For instance, in one example, a convolutional neural network (CNN) can be trained using ‘supervised training methods’ using measurements of in-phase and quadrature part of the signal at the output of an equalizer of baseband processing module 206 and the corresponding labels (e.g., the phase noise power, power amplifier back-off level, DAC resolution, etc.). The number of classes can be specified which is corresponding to the number of HSI indices. The trained CNN can be used to associate the corresponding hardware impairment parameters and the HSI indices to each realization of the received RS.

In another example, an ‘unsupervised training method’ such as k-means clustering can be applied on the measurements at the receiver 202. For example, the in-phase and quadrature signals at the output of the equalizer and cluster the received signals from different hardware conditions into ‘k’ clusters where k is the total number of indices and the received samples associated to each cluster are corresponding to the most similar hardware conditions. The model can be trained based on measurement over different hardware or a hardware subject to different conditions and can be used for identifying the associated HSI based on the received signal.

### HSI Feedback

In one embodiment, receiver 202 provides to transmitter 102 information indicating the HSI. For instance, in one example the information indicating the HSI is transmitted by receiver 202 to transmitter 102 as Uplink Control Information (UCI) on the Physical Uplink Control Channel (PUCCH). In another embodiment, Radio Resource Control (RRC) signaling is used by receiver 202 to communicate the information indicating the HSI to transmitter 102. In one embodiment, the information indicating the HSI comprises or consists of the HSI and the HSI comprises an estimation of the hardware impairment model parameters or a function of it such as a quantized version of the estimated parameters or a compressed version of the parameters.

In another embodiment, a “codebook-based” approach is used. For instance, a codebook of hardware state information of the model parameters can be constructed, where the codebook is known to both the transmitter 102 and the receiver 202. Each codeword of the codebook represents set of values associated to the set of model parameters. A codeword is selected corresponding to the set of model parameters that are close to the estimated model parameters, where a distance metric, e.g. mean square error, can be used to select the codeword that closely represent the estimated parameters. Receiver 202 then sends the selected codeword to transmitter 102, and transmitter 102 constructs an estimate of the parameters using the codebook.

### Compensation of Hardware Impairments

As shown in FIG. 1, in one embodiment, transmitter 102 includes pre-distorter 112, which functions to provide compensation for the distortion due to hardware impairments of components of RF chain 114 and/or 214. In one embodiments, this compensation is performed by applying DPD to the baseband signal provided by baseband unit 110, where the parameters of the DPD are computed such that the effective distortion due to hardware impairments to the transmitted signal or the received signal is minimized. For example, the parameters of the DPD θ_{DPD} can be computed as a function of the received HSI, e.g. hardware impairment model parameters θ_{HW}, such that the transmitted signal or the received signal become close to a linearly scaled version of the input signal to the pre-distorter 112

For example, the parameters of the digital pre distortion θ_{DPD} can be computed as a function of the estimated hardware model parameters θ_{HW} as follows:

$${θ}_{DPD} = arg {min}_{θ} ( ‖ {y}_{d} ( n ) - {f}_{HW} ( {f}_{DPD} ( {y}_{d} ( n ) , θ ) , {θ}_{HW} ) \times g ‖ ) ,$$

where g is the effective gain of the received signal relative to the input of the RF chain, y_{d}(n) is the signal at the output of the RF chain at the receiver side, ƒ_{HW}(x, θ_{HW}) is the hardware characteristic function or model for the identified model parameters θ_{HW} and the input signal x, ƒ_{DPD}(x, θ) is the DPD characteristic function for the given parameters θ and input x. The cost function in the above optimization problem, alternatively, can be the average distance across multiple samples n(n∈{1, . . . , N}), or the maximum distance across multiple samples.

In one example, the DPD function ƒ_{DPD}(x, θ_{DPD}) can be implemented using a parametric function, e.g. a generalized memory polynomial function with coefficients as the DPD parameters to be set as follows:

$${f}_{DPD} ( x [ n ] , {θ}_{DPD} ) = {\sum }_{m = 0}^{{M}_{a}} {\sum }_{k = 1}^{{K}_{a}} {α}_{mk} \times x [ n - m ] \times {\vert x [ n - m ] \vert}^{k - 1} + {\sum }_{m = 0}^{{M}_{b}} {\sum }_{k = 2}^{{K}_{b}} {\sum }_{p = 1}^{P} {β}_{mkp} \times x [ n - m ] \times {\vert x [ n - m - p ] \vert}^{k - 1} + {\sum }_{m = 0}^{{M}_{c}} {\sum }_{k = 2}^{{K}_{c}} {\sum }_{q = 1}^{Q} {γ}_{mkp} \times x [ n - m ] \times {\vert x [ n - m + p ] \vert}^{k - 1}$$

where the DPD parameters are θ_{DPD}={αₘₖ, βₘₖₚ, γₘₖₚ}. These DPD parameters can be found for example by solving the above optimization problem.

In another example, the DPD function ƒ_{DPD}(x, θ_{DPD}) can be implemented using spline models where the DPD function is represented as a linear basis expansion. For example, the DPD function can be represented as follows:

$${f}_{DPD} ( x [ n ] , {θ}_{DPD} ) = {\sum }_{j = 1}^{J} {β}_{j} \times {h}_{j} ( x [ n ] ) ,$$

where in this equation hⱼ (x [n]) is a basis function and βⱼ is model parameter that can be found e.g. by solving the above optimization problem.

The DPD can be alternatively implemented using a look up table, where the input signal is modified as specified in the look up table to create the output signal.

### Providing Update HSI

In one embodiment, receiver 202 updates the HSI and provides the updated HSI to transmitter 102. For example, in one embodiment receiver 202 updates the HSI according to a predefined schedule. The updates can be performed over certain period of time, where the updating period can be tuned depending on the rate of variations of the hardware conditions, e.g. due to temperature variations, traffic variations, speed of mobile terminals, etc., For example, if the maximum temperature variations during time interval ΔT is larger than Tα and is smaller than Tb, then the updating interval of HSI becomes ΔT1, and if the maximum temperature variations during time interval ΔT is larger than Tb and is smaller than Tc, then the updating interval becomes ΔT2.

As another example, in one embodiment receiver 202 updates the HSI in response to receiver 202 detecting an HSI update triggering event. For instance, the update of the HSI can be triggered if a hardware condition is changed (e.g., due to variations in the temperature, traffic load, mobile terminal speed, etc).

As another example, in one embodiment receiver 202 updates the HSI “on-demand.” That is, for example, the update of the HSI estimation can be triggered by transmitter 102 sending an HSI update request to receiver 202. For instance, transmitter 102 can monitor the working condition of the RF chain 114 (e.g. temperature, power consumption, traffic load, . . . ) and if transmitter 102 detects a large enough change (e.g. if the temperature changed larger than a threshold value T1), then transmitter 102 sends a request to receiver 202 to provide an update of the HSI.

### UE and BS Embodiments

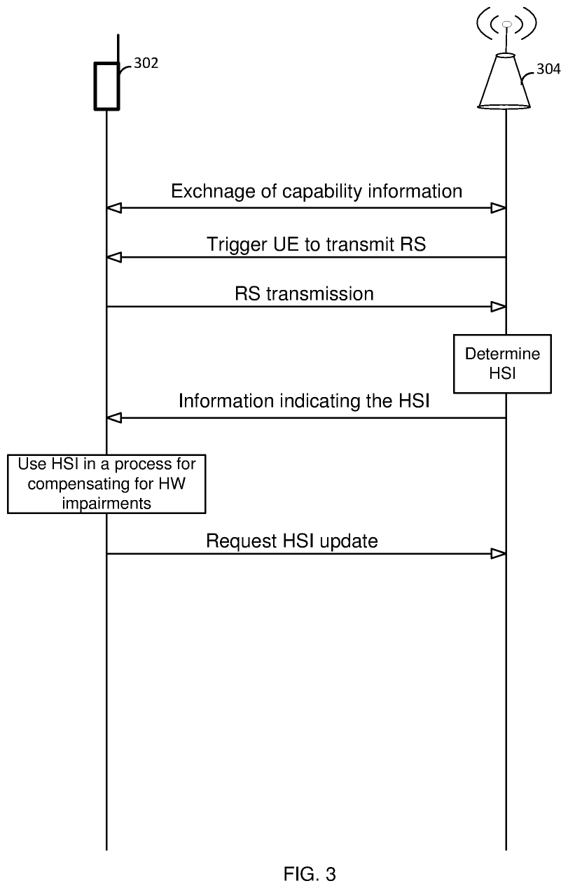

FIG. 3 is a message flow diagram illustrating an embodiment in which transmitter 102 is a component of a UE 302 (as used herein a UE is any device capable of wireless communication with a BS 304) and receiver 202 is a component of BS 304. In such an embodiment, the UE may inform the BS of its capability to transmit RSs for HSI generation; likewise, the BS may inform the UE of its capability to generate and provide HSI to the UE. If the BS learns that the UE is capable of sending the RSs, the BS may trigger the UE to transmit the RSs. Upon receiving the trigger message (e.g., Downlink Control Information or an RRC message), the UE sends to the BS an RS for HSI estimation. The BS then, based on the RS, generates HSI and provides to the UE information indicating the HSI. The UE uses the HSI to compensate for distortion caused by one or more hardware (HW) components of the transmitter and/or one or more HW components of the receiver. At some later point in time, the UE may request an HSI update (e.g., UE may trigger BS to schedule a RS transmission from the UE).

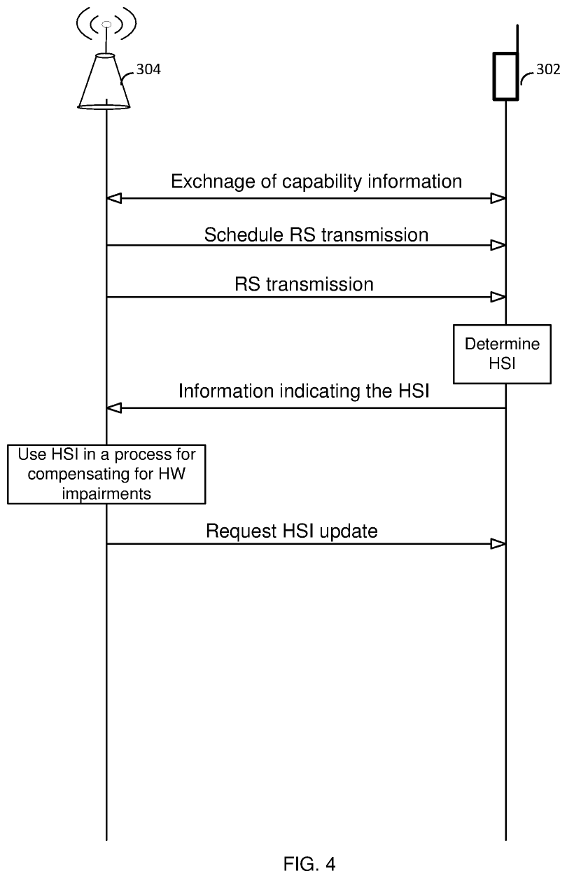

FIG. 4 is a message flow diagram illustrating an embodiment in which transmitter 102 is a component of BS 304 and receiver 202 is a component of UE 302. In such an embodiment, the UE may signal to the BS the UE's capability to generate and provide HSI to the BS; likewise, the BS may transmit (e.g., unicast or broadcast) information indicating the BS' ability to use HSI to compensate for hardware impairments and the ability to transmit RSs to enable the UE to generate the HSI. After the exchange of capability information, the BS may schedule the transmission of a RS and transmit the RS according to the schedule. The UE, after receiving the RS, determines HSI based on the received RS and then sends to the BS information indicating the determined HSI. Upon receiving the information indicating the HSI, the BS uses the information to compensate for distortion caused by one or more hardware components of the transmitter and/or one or more hardware components of the receiver. At some later point in time, the BS may request an HSI update (e.g., BS may schedule an RS transmission).

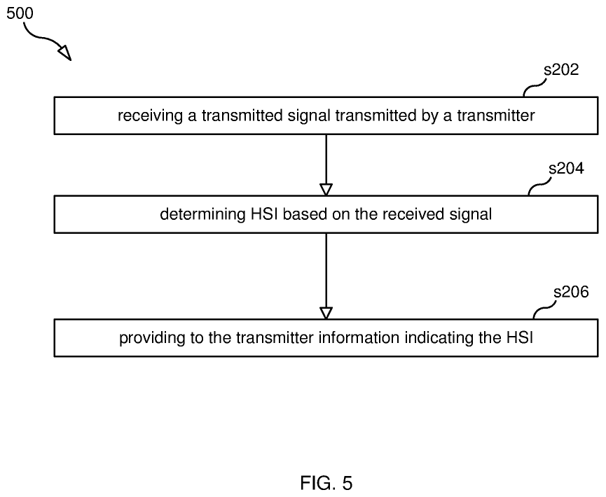

FIG. 5 is a flowchart illustrating a process 500 according to an embodiment that is performed by receiver 202 for hardware impairment compensation. Process 500 may begin in step s502. Step s502 comprises receiving a transmitted signal (e.g., an RS) transmitted by a transmitter (e.g., transmitter 102). Step s504 comprises determining HSI based on the received signal. Step s506 comprises providing to the transmitter information indicating the HSI, wherein the HSI comprises information that enables the transmitter to compensate for distortion caused by one or more hardware components of the transmitter and/or one or more hardware components of the receiver.

In some embodiments, the HSI comprises information that enables the transmitter to determine coefficients for a pre-distortion function that is used to compensate for the distortion.

In some embodiments, model parameters for a model representing the hardware components or information enabling the transmitter to determine the model parameters. In some embodiments, the HSI comprises the information enabling the transmitter to determine the model parameters, and the information enabling the transmitter to determine the model parameters comprises information pertaining to the received signal. In some embodiments, the information pertaining to the received signal comprises: information indicating a phase shift between the transmitted signal and the received signal and/or information indicating an amplitude change between the transmitted signal the received signal.

In some embodiments, the one or more hardware components of the transmitter comprises: a power amplifier; a digital-to-analog converter; a filter; and/or an oscillator.

In some embodiments, determining the HSI comprises determining, using the received signal, parameter values of a parametrized model that models one or more of the hardware components. In some embodiments, the signal transmitted by the transmitter is a reference signal known to the receiver prior to the transmission. In some embodiments, determining the parameter values of the parametrized model comprises: applying the model to the reference signal to produce a model output signal; and using the received signal and the model output signal to determine the parameter values of the parametrized model. In some embodiments, using the received signal and the model output signal to determine the parameter values of the parametrized model comprises determining parameter values of the parametrized model that minimize a difference metric between the received signal and the model output signal produced by the parametrized model.

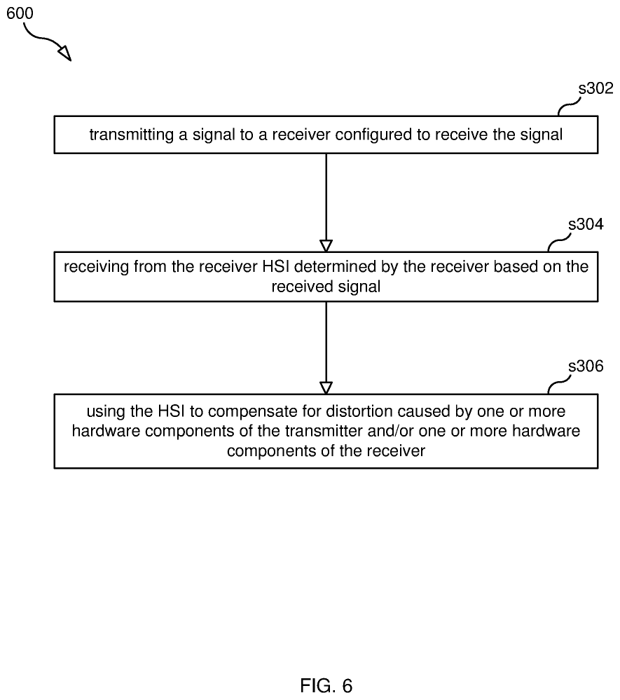

FIG. 6 is a flowchart illustrating a process 600 according to an embodiment that is performed by transmitter 102. Process 600 may begin in step s602. Step s602 comprises transmitting a signal (e.g., an RS) to a receiver configured to receive the signal. Step s604 comprises receiving from the receiver information indicating HSI determined by the receiver based on the received signal. Step s606 comprise using the information indicating the HSI to compensate for distortion caused by one or more hardware components of the transmitter and/or one or more hardware components of the receiver.

In some embodiments, using the information indicating the HSI to compensate for the distortion comprises using the HSI to determine coefficients for a pre-distortion function that is used by the transmitter to compensate for the distortion.

In some embodiments, the information indicating the HSI comprises model parameters for a model representing the hardware components or information enabling the transmitter to determine the model parameters. In some embodiments, the information indicating the HSI comprises the information enabling the transmitter to determine the model parameters, and the information enabling the transmitter to determine the model parameters comprises information pertaining to the received signal. In some embodiments, information pertaining to the received signal comprises: information indicating a phase shift between the transmitted signal and the received signal and/or information indicating an amplitude change between the transmitted signal the received signal.

In some embodiments the process also includes, after using the information indicating the HSI to determine the coefficients for the pre-distortion function, applying the pre-distortion function with the determined coefficients to a baseband signal to produce a pre-distorted signal. In some embodiments, the pre-distorted signal is a digital signal and the method further comprises: converting the pre-distorted signal to an analog signal; using the analog signal and a modulator to produce a modulated signal; amplifying the modulated signal using a power amplifier, thereby producing an amplified signal; and transmitting the amplified signal.

In some embodiments, the signal transmitted by the transmitter is a reference signal known to the receiver prior to the transmission.

In some embodiments the process also includes triggering the receiver to provide the HSI to the transmitter. In some embodiments, the triggering is performed as a result of a change in a working condition of the transmitter.

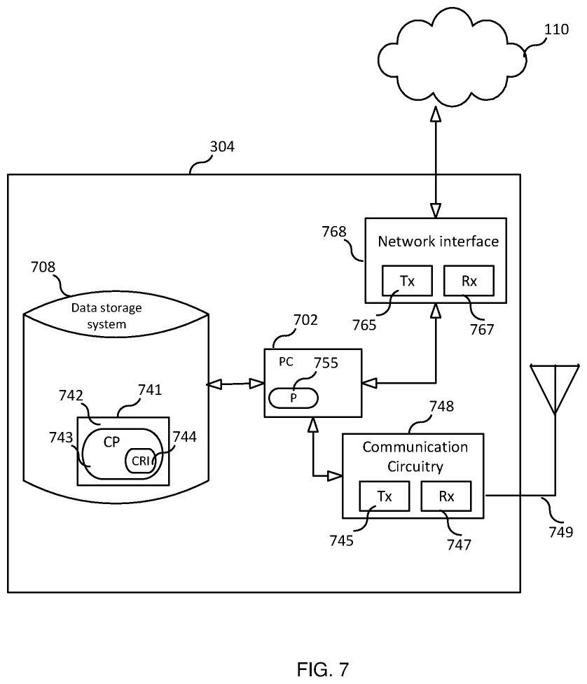

FIG. 7 is a block diagram of BS 304, according to some embodiments. As shown in FIG. 7, BS 304 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., BS 304 may be a distributed computing apparatus where some function are performed in one location and other functions performed in another location); at least one network interface 768 comprising a transmitter (Tx) 765 and a receiver (Rx) 767 for enabling BS 304 to transmit data to and receive data from other nodes connected to a network 110 (e.g., an Internet Protocol (IP) network) to which network interface 768 is connected; communication circuitry 748, which is coupled to an antenna arrangement 749 comprising one or more antennas and which comprises a transmitter (Tx) 745 and a receiver (Rx) 747 for enabling BS 304 to transmit data and receive data (e.g., wirelessly transmit/receive data); and a local storage unit (a.k.a., “data storage system”) 708, which may include one or more non-volatile storage devices and/or one or more volatile storage devices. Tx 745 and/or Rx 747 may comprise transmitter 102 and/or receiver 202, respectively. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes BS 304 to perform steps described herein (e.g., steps described herein with reference to the flow charts). In other embodiments, BS 304 may be configured to perform steps described herein without the need for code. That is, for example, PC 702 may consist merely of one or more ASICs. Hence, the features of the embodiments described herein may be implemented in hardware and/or software.

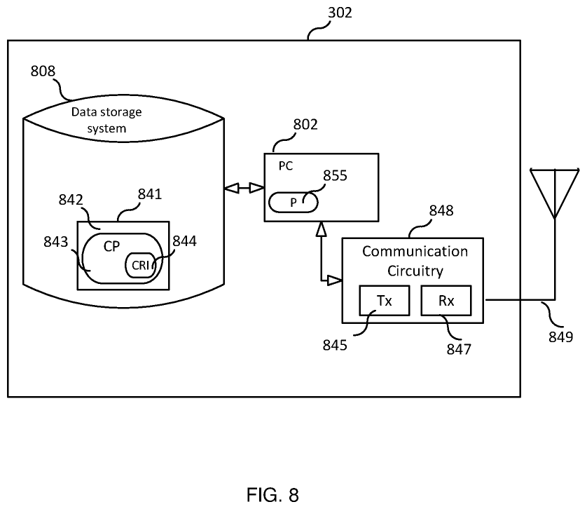

FIG. 8 is a block diagram of UE 302, according to some embodiments. As shown in FIG. 8, UE 302 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like); communication circuitry 848, which is coupled to an antenna arrangement 849 comprising one or more antennas and which comprises a transmitter (Tx) 845 and a receiver (Rx) 847 for enabling UE 302 to transmit data and receive data (e.g., wirelessly transmit/receive data); and a storage unit (a.k.a., “data storage system”) 808, which may include one or more non-volatile storage devices and/or one or more volatile storage devices. Tx 845 and/or Rx 847 may comprise transmitter 102 and/or receiver 202, respectively. In embodiments where PC 802 includes a programmable processor, a computer readable medium (CRM) QQ342 may be provided. CRM QQ342 stores a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes UE 302 to perform steps described herein (e.g., steps described herein with reference to the flow charts). In other embodiments, UE 302 may be configured to perform steps described herein without the need for code. That is, for example, PC 802 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a receiver for hardware impairment compensation, the method comprising:
receiving a transmitted signal transmitted by a transmitter;
determining hardware state information (HSI) based on the received signal; and
providing to the transmitter information indicating the HSI, wherein
the HSI comprises information that enables the transmitter to compensate for distortion caused by at least one of one or more hardware components of the transmitter or one or more hardware components of the receiver.

2. The method of claim 1, wherein the information indicating the HSI comprises information that enables the transmitter to determine coefficients for a pre-distortion function that is used to compensate for the distortion.

3. The method of claim 1, wherein the information indicating the HSI comprises:
model parameters for a model representing the hardware components, or
information enabling the transmitter to determine the model parameters.

4. The method of claim 3, wherein the information indicating the HSI further comprises:
the information enabling the transmitter to determine the model parameters, and
the information enabling the transmitter to determine the model parameters comprises information pertaining to the received signal.

5. The method of claim 4, wherein information pertaining to the received signal comprises at least one of:
information indicating a phase shift between the transmitted signal and the received signal, or
information indicating an amplitude change between the transmitted signal the received signal.

6. The method of claim 1, wherein the one or more hardware components of the transmitter comprises:
a power amplifier;
a filter;
a digital-to-analog converter; or
an oscillator.

7. The method of claim 1, wherein determining the HSI further comprises determining, using the received signal, parameter values of a parametrized model that models one or more of the hardware components.

8. The method of claim 7, wherein the signal transmitted by the transmitter is a reference signal known to the receiver prior to the transmission.

9. The method of claim 7, wherein determining the parameter values of the parametrized model comprises:
applying the model to the received signal to produce a model output signal; and
using the received signal and the model output signal to determine the parameter values of the parametrized model.

10. The method of claim 9, wherein using the received signal and the model output signal to determine the parameter values of the parametrized model comprises determining parameter values of the parametrized model that minimize a difference metric between the received signal and the model output signal produced by the parametrized model.

11. A method performed by a transmitter, the method comprising:
transmitting a signal to a receiver configured to receive the signal;
receiving from the receiver information indicating hardware state information (HSI) determined by the receiver based on the received signal; and
using the information indicating the HSI to compensate for distortion caused by at least one of one or more hardware components of the transmitter or one or more hardware components of the receiver.

12. The method of claim 11, wherein using the information indicating the HSI to compensate for the distortion comprises using the information indicating the HSI to determine coefficients for a pre-distortion function that is used by the transmitter to compensate for the distortion.

13. The method of claim 11, wherein the information indicating the HSI comprises:
model parameters for a model representing the hardware components, or
information enabling the transmitter to determine the model parameters.

14. The method of claim 13, wherein the information indicating the HSI further comprises:
the information enabling the transmitter to determine the model parameters, and
the information enabling the transmitter to determine the model parameters comprises information pertaining to the received signal.

15. The method of claim 14, wherein information pertaining to the received signal comprises at least one of:
information indicating a phase shift between the transmitted signal and the received signal, or
information indicating an amplitude change between the transmitted signal the received signal.

16. The method of claim 12, further comprising:
after using the information indicating the HSI to determine the coefficients for the pre-distortion function, applying the pre-distortion function with the determined coefficients to a baseband signal to produce a pre-distorted signal.

17. The method of claim 16, wherein the pre-distorted signal is a digital signal and the method further comprises:
converting the pre-distorted signal to an analog signal;
using the analog signal and a modulator to produce a modulated signal;
amplifying the modulated signal using a power amplifier, thereby producing an amplified signal; and
transmitting the amplified signal.

18. (canceled)

19. The method of claim 11, further comprising triggering the receiver to provide the information indicating the HSI to the transmitter.

20. The method of claim 19, wherein the triggering is performed as a result of a change in a working condition of the transmitter.

21-22. (canceled)

23. A network node, the network node being configured to:
receive a transmitted signal transmitted by a transmitter;
determine hardware state information (HSI) based on the received signal; and
provide to the transmitter information indicating the HSI, wherein
the HSI comprises information that enables the transmitter to compensate for distortion caused by at least one of one or more hardware components of the transmitter or one or more hardware components of the receiver.

24-26. (canceled)
